(19) United States
(12) Patent Application Publication
(10) Pub. No.: US 2010/0205473 A1
(43) Pub. Date: Aug. 12, 2010

(54) SYNCHRONIZATION OF TWO COMMUNICATION NETWORKS OF AN ELECTRONIC DATA-PROCESSING SYSTEM

(76) Inventors: Juergen Schirmer, Heidelberg (DE); Andreas-Juergen Rohatschek, Wernau/Neckar (DE); Harald Weiler, Goeppingen (DE); Clemens Schroff, Kraichtal (DE); Thomas Hogenmueller, Palo Alto, CA (US)

Correspondence Address: KENYON & KENYON LLP, ONE BROADWAY, NEW YORK, NY, 10004, US

(21) Appl. No.: 12/699,400

(22) Filed: Feb. 3, 2010

(30) Foreign Application Priority Data
Feb. 3, 2009 (DE) 102009000581.1

(51) Int. Cl. G06F 1/04

(52) U.S. Cl. 713/600

(57) ABSTRACT

A method for synchronizing two communication networks of an electronic data-processing system. One or a plurality of nodes is connected to the two communication networks in each case. Each of the two communication networks has a schedule, which specifies at least one time slot for a synchronization message. One of the nodes of the first communication network, and one of the nodes of the second communication network are linked to one another by a shared arithmetic unit. A deviation between the time slots for the synchronization messages on the two communication networks is determined as a function of the schedules of the two communication networks. The deviation is used to determine correction values, which are forwarded to at least one other node. The occurrence of the time slots for the synchronization messages is modified by the other node as a function of the correction values.

### CROSS REFERENCE

The present application claims the benefit under 35 U.S.C. §119 of German Patent Application No. 102009000581.1 filed on Feb. 3, 2009, which is expressly incorporated herein in its entirety.

### FIELD OF THE INVENTION

The present invention relates to a method for synchronizing two communication networks, and to an electronic data-processing system.

### BACKGROUND INFORMATION

In a motor vehicle, for example, a plurality of control devices is interconnected via one or more communication networks in the electronic data-processing system provided in the vehicle. The communication networks may be bus-type or star-shaped systems, for instance. The control devices are provided to perform specific functions, such as fuel-injection or steering or braking functions of the motor vehicle.

For example, if two so-called event-driven communication networks are present, these communication networks are conventionally interconnected with the aid of what is commonly referred to as a gateway. The gateway is responsible for converting and possibly buffer-storing the data transmitted following what is known as an interrupt on the first communication network, for example, such that these data are then able to be forwarded to the second communication network and transmitted further from there. This conversion and buffer-storage entails time delays in forwarding the data from the first communication network to the second communication network.

In what is called a time-driven communication network, there exists a fixedly specified flow chart (known as a schedule), which specifies a specific time slot to each connected control device during which this control device is able to transmit data via the communication network. Furthermore, the schedule also specifies at least one time slot which contains a synchronization message, with whose aid all control devices connected to the communication network are able to synchronize with each other as a function of time.

If two time-driven communication networks are present, and if the intention is to link these two communication networks to each other, then it is advantageous to synchronize the two communication networks with each other temporally as well.

### SUMMARY

An object of the present invention is to synchronize two communication networks of an electronic data-processing system.

To synchronize two communication networks of an electronic data-processing system according to the present invention, one or a plurality of nodes is connected to the two communication networks in each case; each of the two communication networks has a schedule which specifies at least one time slot for a synchronization message, one of the nodes of the first communication network and one of the nodes of the second communication network are linked to one another by a shared arithmetic unit, a deviation between the time slots for the synchronization messages on the two communication networks is determined as a function of the schedules of the two communication networks, correction values are determined from the deviation and forwarded to at least one other node, and the other node varies the occurrence of the time slots for the synchronization messages as a function of the correction values.

Thus, the occurrence of the time slots for the synchronization messages on one of the two communication networks is shifted in time with the aid of the correction values. This achieves an adaptation of these time slots to the corresponding time slots of the other communication network, and thus ultimately a synchronization of the two communication networks. An advantage of the present invention consists of the fact that it generally requires no additional hardware; instead, the synchronization of the two communication networks is realizable largely by software. In this way, the present invention may be utilized in a flexible and cost-effective manner, possibly also retroactively.

It is especially advantageous if an individual communication controller of the two nodes forwards the schedules of the two communication networks to a program of an application layer of the arithmetic unit via one or a plurality of software modules, and if the correction values are forwarded to the other node by the program of the application layer of the arithmetic unit via the software module(s). These software modules are preferably able to realize a layer model that is based on the OSI communication model, in particular. In this way the advantages of the OSI communication model especially with regard to a reliable transmission of the aforementioned data are utilized in the present invention as well.

Analogously, it is advantageous if the other node also has an arithmetic unit, and if a communication controller of the other node forwards the correction values to a program of an application layer of the arithmetic unit via one or a plurality of software module(s), especially via the OSI communication model.

Additional features, application options and advantages of the present invention ensue from the following description of exemplary embodiments of the present invention, which are illustrated in the figures. For this purpose, all of the described or illustrated features form the subject of the present invention, either alone or in any combination, irrespective of their combination in the patent claims or their antecedent references and also irrespective of their individual formulation and illustration in the description and in the figures.

### BRIEF DESCRIPTION OF THE DRAWINGS

FIG. 1 shows a schematic circuit diagram of an exemplary embodiment of a synchronization of two communication networks according to the present invention.

FIG. 2 shows a detailed cut-away portion from the circuit diagram of FIG. 1.

### DETAILED DESCRIPTION OF EXAMPLE EMBODIMENTS

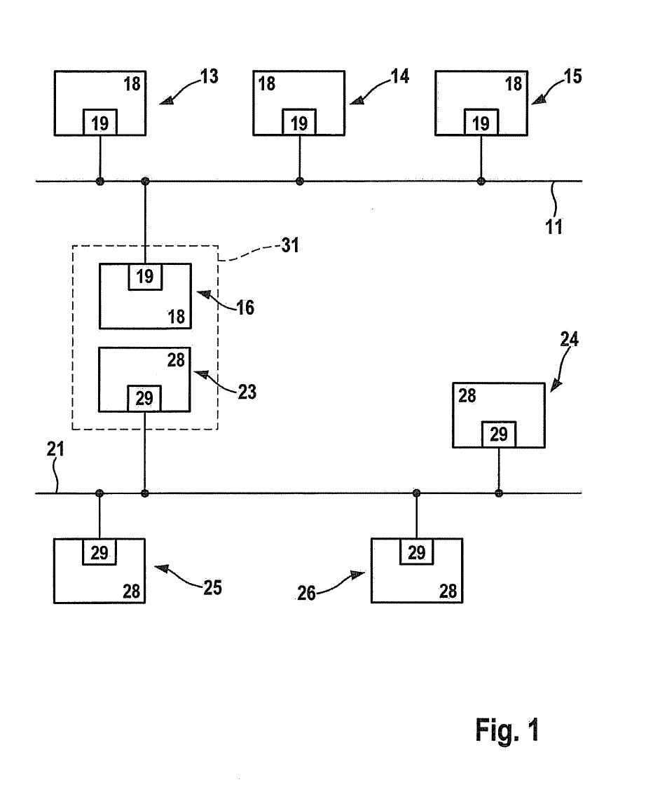

FIG. 1 shows a first bus 11 of an electronic data-processing system, which may be any type of time-driven communication network. For example, bus 11 may be realized as a so-called FlexRay bus or as a so-called TTCAN bus. Bus 11 is provided for the transmission of digital data in a motor vehicle, in particular.

Four nodes 13, 14, 15, 16 are connected to bus 11 by way of example. A node, for instance, may be a component of a control device, which control device is able to perform one or a plurality of functions, e.g., functions with regard to the injection of fuel into an internal combustion engine, or steering or braking functions of a motor vehicle.

Each node 13, 14, 15, 16 has a communication controller 18 and a bus transceiver 19. Bus transceiver 19 establishes the direct connection of the associated node with bus 11 by writing to bus 11 electrical signals representing the digital data to be transmitted. Communication controller 18 implements a predefined flow chart, a so-called schedule, by, inter alia, transferring the digital data to be transmitted to bus transceiver 19 at the correct instant for transmission.

The schedule subdivides the transmission time available on the bus into successive cycles, each of which includes, inter alia, a plurality of time slots. Each time slot can accommodate a message, a so-called frame, and each message contains, among other things, a number of digital data items to be transmitted, which is known as a payload.

The time schedule assigns to each node 13, 14, 15, 16 at least one specific time slot in the successive cycles, so that in each cycle, each node 13, 14, 15, 16 is able to write a quantity of digital data onto bus 11, and therefore is able to transmit it via bus 11. Preferably, a plurality of time slots per cycle is assigned to the individual nodes 13, 14, 15, 16.

For the temporal synchronization of nodes 13, 14, 15, 16, the schedule specifies that at least one of nodes 13, 14, 15, 16 transmits a synchronization message in one of the specific time slots available to it in the successive cycles. Such synchronization messages are preferably transmitted by a plurality of nodes 13, 14, 15, 16 within the time slots available to them. Thus, one or a plurality of synchronization messages is present on bus 11 in each cycle.

The schedule is known in all nodes 13, 14, 15, 16. Thus, all nodes 13, 14, 15, 16 “know” in which time slots the synchronization messages are transmitted on bus 11.

The individual time slots of the schedule are determined in each node 13, 14, 15, 16 on a time basis that is a function of a quartz oscillator, for example. Since the time bases available to individual nodes 13, 14, 15, 16 may deviate from each other, for instance because of different quartzes, it is possible that one of the other nodes is unable to precisely determine the particular time slot in which a synchronization message is written to bus 11 by a certain node; instead, it can determine it only with a slight deviation.

Because the deviation is only slight und because an interval between the messages of two successive time slots in which no data are transmitted is always provided by the schedule, the aforementioned other node is able to read in the synchronization message of the particular node via its bus transceiver 19 despite the slight deviation. The other node can then determine the mentioned deviation as a function of the read-in synchronization message and compensate for it by correcting its time base arithmetically. As a result, the other node is able to synchronize itself to the read-in synchronization message.

Overall, all nodes 13, 14, 15, 16 connected to bus 11 are able to synchronize themselves with each other in this manner with the aid of the transmitted synchronization messages.

The data-processing system of FIG. 1 includes a second bus 21, which is comparable to bus 11 or which corresponds to bus 11, and which may be any type of a time-controlled communication network. For example, bus 21 may be realized as a so-called FlexRay bus or as a so-called TTCAN bus. Four nodes 23, 24, 25, 26 are connected to bus 21 by way of example. Nodes 23, 24, 25, 26 are comparable to nodes 13, 14, 15, 16 of bus 11 and may, for instance, be part of a control device. Each node 23, 24, 25, 26 of bus 21 has a communication controller 28 and a bus transceiver 29, which are likewise comparable to communication controller 18 and bus transceiver 19 of bus 11.

The method of functioning of nodes 23, 24, 25, 26 corresponds to the method of functioning of nodes 13, 14, 15, 16. Especially the definition of cycles and time slots with the aid of the schedules is provided for nodes 23, 24, 25, 26 of second bus 21 in the same way as for nodes 13, 14, 15, 16 of first bus 11. Furthermore, the schedules for the two buses 11, 21 agree at least with regard to the presence of the time slots for the synchronization messages. However, the occurrence of the time slots for the synchronization messages on the two buses 11, 21 may also deviate temporally. The bus protocols for the two buses 11, 21 may also differ with regard to the other time slots.

Thus, synchronization messages are generated on both buses 11, 21 by at least one of the individual nodes there and transmitted via the particular bus. The individual nodes connected to the corresponding bus are thereby able to synchronize with each other with the aid of the transmitted synchronization messages. However, a synchronization of the two buses 11, 21 does not exist yet in this regard.

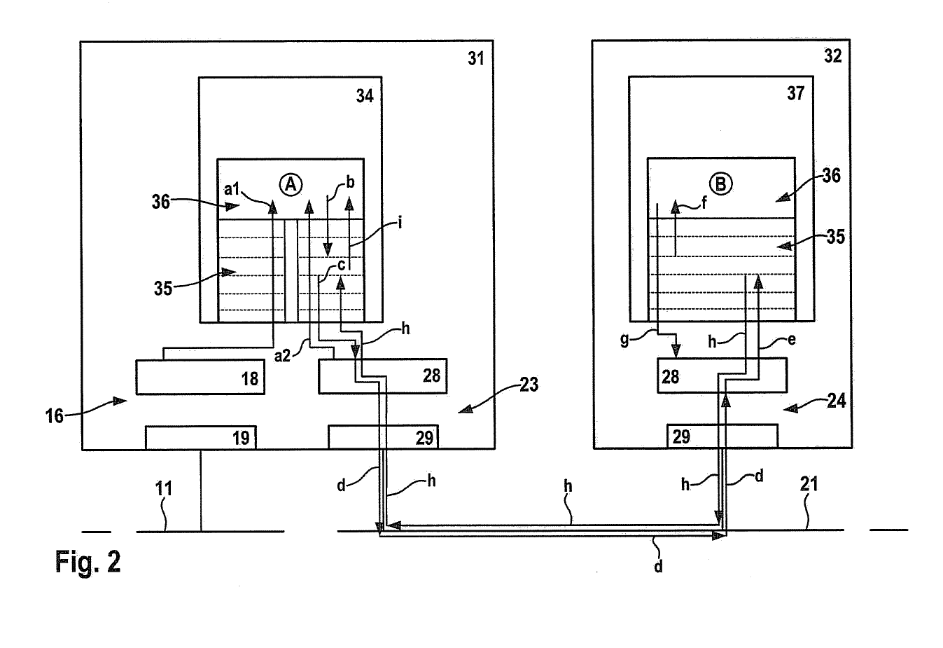

It is now assumed that node 16 connected to first bus 11, and node 23 connected to second bus 21 are realized in one and the same control device 31. Furthermore, it is assumed by way of example that node 24 of second bus 21 is accommodated in a different control device 32. These two control devices 31, 32 are shown in detail in FIG. 2.

According to FIG. 2, control device 31 has the two nodes 16, 23 having communication controllers 18, 28 and associated bus drivers 19, 29 included therein. Control device 31 is connected to first bus 11 via node 16, and to second bus 21 via node 23. In addition, control device 32 of FIG. 2 has node 24 including communication controller 28 and bus driver 29, this node 24 being connected to second bus 21.

In control device 31 the two nodes 16, 23 are linked to an arithmetic unit 34, on which computer programs for carrying out specific tasks and functions are able to be executed. Arithmetic unit 34 realizes one or a plurality of software module(s). Preferably, a layer model based on the conventional 7-layer OSI communication model according to the ISO standard is made available (OSI=open systems interconnection; ISO=International Standardization Organization). This is represented by reference number 35 in FIG. 2. Moreover, arithmetic unit 34 provides a so-called application layer, which forms the seventh layer of the OSI communication model from a logical point of view, and which is denoted by reference numeral 36 in FIG. 2.

It has been explained that the schedule of first bus 11 and thus also the time slots including the synchronization messages of first bus 11 are known in node 16, i.e., its communication controller 18. Analogously, the schedule of second bus 21 and thus the time slots including the synchronization messages of second bus 21, are known in node 23, i.e., its communication controller 28.

The two communication controllers 18, 28 forward this time information pertaining to the aforementioned time slots on the two buses 11, 21 to a program A in application layer 36 via the layers of layer model 35. This is denoted by reference symbols a1, a2 in FIG. 2.

Program A then performs a comparison of the received time information and determines a possibly existing deviation between the mentioned time slots on the two buses 11, 21. From this deviation program A determines correction values with whose aid the occurrence of the mentioned time slots of second bus 21 are modified in such a way that the deviation should at least become smaller or, if possible, minimal or even become zero.

Program A of application layer 36 transmits these correction values to communication controller 28 of node 23 via the layers of layer model 35. This is denoted by reference symbols b, c in FIG. 2.

Communication controller 28 of node 23 forwards the correction values to communication controller 28 of all other nodes 24, 25, 26 of bus 21. This is exemplarily shown in FIG. 2 in that the correction values are forwarded to communication controller 28 of node 24. This forwarding is indicated by reference symbol d in FIG. 2.

Analogously to node 23, control device 32 has an arithmetic unit 37 which is linked to node 24 and by which a layer model 35 based on the conventional 7-layer OSI communication model according to the ISO standard is made available. Furthermore, arithmetic unit 37 supplies application layer 36, which once again forms the seventh layer of the OSI communication model from a logical point of view.

Communication controller 28 of node 24 forwards the correction values via the layers of layer model 35 to a program B in application layer 36. This is denoted by reference symbols e, f in FIG. 2.

Program B then influences communication controller 28 of node 24 as a function of these correction values via the layers of layer model 35, in such a way that a change comes about in the time ratios of the time slots written to second bus 21 via bus driver 29 of node 24. In particular, it is possible to insert an offset between the time slots, or the mentioned time basis of node 24 may be modified arithmetically. This influence is represented by reference symbol g in FIG. 2.

The receipt of the correction values is confirmed by layer model 35 of arithmetic unit 37. This is represented by reference symbol h in FIG. 2. Layer model 35 of arithmetic unit 34 reports corresponding feedback from all nodes 24, 25, 26 of bus 21 to program A of application layer 36 of arithmetic unit 34. This is denoted by reference symbol i in FIG. 2.

The previously explained modification of the time ratios of the time slots, implemented as a function of the correction values, which correction values are written to second bus 21 via bus driver 29 of node 24, is performed simultaneously in all nodes 23, 24, 25, 26 of second bus 21. This has the result that the time ratios of the time slots on second bus 21 change as a whole. The time ratios for the synchronization messages on second bus 21 therefore change as well.

Using the correction values, it is therefore possible to shift the time slots for the synchronization messages on the second bus in time. In this way the temporal occurrence of these time slots is able to be adapted to the occurrence of the corresponding time slots for the synchronization messages of first bus 11. The two buses 11, 21 are therefore able to be synchronized with each other with the aid of the correction values.

What is claimed is:

1. A method for synchronizing two communication networks of an electronic data-processing system, one or a plurality of nodes being connected to the two communication networks, and each of the two communication networks having a schedule, which specifies at least one time slot for a synchronization message, the method comprising:
linking one of the nodes of a first one of the communication networks and one of the nodes of a second one of the communication networks to one another by a shared arithmetic unit;
determining a deviation between time slots for synchronization messages on the two communication networks as a function of the schedules of the two communication networks;
determining correction values from the deviation;
forwarding the correction values to at least one other node; and
modifying by the other node an occurrence of the time slots for the synchronization messages as a function of the correction values.

2. The method as recited in claim 1, further comprising:
forwarding by a communication controller of each of the two nodes the schedules to a program of an application layer of the shared arithmetic unit via at least one software module.

3. The method as recited in claim 2, wherein the schedules are forwarded via a layer model based on an OSI communication model.

4. The method as recited in claim 2, wherein the correction values are determined by the program of the application layer of the arithmetic unit.

5. The method as recited in claim 2, wherein the correction values are forwarded to the other node by the program of the application layer of the arithmetic unit via the at least one software module.

6. The method as recited in claim 1, wherein the other node has an arithmetic unit, and a communication controller of the other node forwards the correction values to a program of an application layer of the shared arithmetic unit via at least one software module.

7. The method as recited in claim 6, wherein the other node forwards the correction values via a layer model based on an OSI communication model.

8. The method as recited in claim 6, the occurrence of the time slots for the synchronization messages being modified by the program of the application layer of the arithmetic unit.

9. A storage device storing a computer program for an electronic arithmetic unit computer program for synchronizing two communication networks of an electronic data-processing system, one or a plurality of nodes being connected to the two communication networks, and each of the two communication networks having a schedule, which specifies at least one time slot for a synchronization message, the computer program, when executed by the electronic arithmetic unit, causing the computer device to perform the steps of:
linking one of the nodes of a first one of the communication networks and one of the nodes of a second one of the communication networks to one another via the electronic arithmetic unit, the electronic arithmetic unit being a shared arithmetic unit;
determining a deviation between time slots for synchronization messages on the two communication networks as a function of the schedules of the two communication networks;
determining correction values from the deviation;
forwarding the correction values to at least one other node; and
modifying by the other node an occurrence of the time slots for the synchronization messages as a function of the correction values.

10. An electronic data-processing device, comprising:
two communication networks, each of the two communication networks having a schedule, which specifies at least one time slot for a synchronization message;
at least one node connected to each of the two communication networks, wherein one of the nodes of a first one of the communication networks, and one of the nodes of a second one of the communication networks are linked to one another via a shared arithmetic unit, the arithmetic unit being adapted so that a deviation between time slots for synchronization messages on the two communication networks as a function of the schedules of the two communication networks is determined, and correction values are determined from the deviation and forwarded to at least one other node, the other node having an arithmetic unit which is configured in such a way that an occurrence of the time slots for the synchronization messages is modified as a function of the correction values.

11. The data-processing system as recited in claim 11, wherein the shared arithmetic unit and the arithmetic unit of the other node are designed to realize a layer model.

12. The data-processing system as recited in claim 11, wherein the layer model is an OSI communication model.

13. The data-processing system as recited in claim 10, wherein the two communication networks are time-driven communication networks.

14. The data-processing system as recited in claim 13, wherein the two communication networks include FlexRay buses.

15. The data-processing system as recited in claim 11, wherein the nodes in each case being a component of a control unit, and one or more functions in a motor vehicle being executable by the control unit, the functions including at least one of injection of fuel into an internal combustion engine of the motor vehicle, steering, and braking functions of the motor vehicle.
